(19) United States
(12) Patent Application Publication
(10) Pub. No.: US 2007/0107218 A1
(43) Pub. Date: May 17, 2007

(54) Formed tenons for gas turbine stator vanes

(75) Inventors: Nicholas P. Poccia, Gansevoort, NY (US); Erik K. Jacobson, Pattersonville, NY (US); Nicholas F. Martin, Simpsonville, SC (US); Raymond H. Goetze, Greenville, SC (US); Lynn C. Gagne, Simpsonville, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/261,559

(22) Filed: Oct. 31, 2005

(51) Int. Cl. B23P 15/04

(52) U.S. Cl. 29/889.2; 29/509

(57) ABSTRACT

A method of attaching a shroud cover segment to a plurality of gas turbine compressor stator vanes includes: (a) forming each of the plurality of stator vanes with at least one tenon extending from a radially inner tip of each of the stator vanes; (b) forming the shroud cover segment with at least one aperture for each of the at least one tenon; (c) locating the plurality of stator vanes and the shroud cover segment such that the at least one tenon of each of the stator vanes projects through a respective aperture in the shroud cover; and (d) forming the at least one tenon of each of the plurality of stator vanes to create an enlarged tenon head on each of the tenons, thereby fixing the shroud cover segment to the plurality of stator vanes.

### BACKGROUND OF THE INVENTION

This invention relates generally to gas engine technology and, more specifically, to the installation of fixed shrouds on stator vanes.

Installing shrouds on stator vanes is a well known method for tuning the airfoil modal response due to aerodynamic flow excitation. More specifically, rotationally fixed stator vanes are often shrouded at the aft end of a gas turbine compressor where flow can be multidirectional and cause unshrouded vanes to suffer from aerodynamic stimuli. A shroud or cover ties sets of vanes together and generally results in a more robust design to address this aerodynamic stimulus issue.

Current industrial gas turbine compressor stator shrouds are welded or bolted to the stator vanes. To date, the manufacturing method of choice for fixed end boundary conditions is welding or casting, and for torsional free end boundary conditions, bolting and swaging.

Welding typical gas turbine compressor materials requires preheat treatment, postheat treatment, and final machining of the assembly to remove heat induced distortion. Accordingly, the skill level required to fabricate a typical welded shroud assembly is high.

The bolting methodology requires a minimum vane thickness to allow a tapped hole to be installed in a tenon by, for example, drilling, in the top of the vane. Positioning the vane during the drilling operation is critical to avoid breakout of the tenon wall. The bolt size is limited by the thickness of the vane and, on smaller gas turbines, the vane may not be thick enough to support a tenon with a tapped hole without a change to the airfoil design. With this technique, extra parts are introduced into the assembly such as bolts, washers, and bushings. Moreover, a bolted assembly can be over-torqued and the bolt can be subject to high preloading, potentially leading to premature failure in service.

Casting has also been used over the years but can be expensive, and long time intervals are required to develop the casting molds. In addition, some typical compressor stator vane materials cannot be readily cast, resulting in a high rejection rate.

Accordingly, there remains a need for a simplified manufacturing process for attaching tip shrouds to stationary gas turbine stator vanes resulting in lower cost and a shorter delivery cycle as compared to current methods of attachment.

### BRIEF DESCRIPTION OF THE INVENTION

In an exemplary embodiment, this invention replaces the conventional welded or bolted attachment between shroud covers and stationary gas turbine stator vanes with a formed attachment. More specifically, in the exemplary embodiment, the radially inner tip of the stator vane is formed with a pair of radially inwardly extending tenons. The shroud cover is formed with a pair of corresponding holes adapted to receive a respective pair of tenons on each stator vane engaged by the shroud cover. The tenons are then formed by otherwise conventional tooling to secure the shroud to the set of vanes. By taking an otherwise common manufacturing process and applying it in an area where it has not previously utilized, several advantages are gained. For example, tenon forming can be accomplished with little or no change to the existing air foil shape; preheat treatment is eliminated; formed tenons can be tailored to provide frequency tuning for new designs; and the cost to form the tenons is an order of magnitude less expensive than welding. In addition, cycle time is greatly reduced over welding, and no machining is required after assembly due to process distortion. Tenon size in a formed configuration is also generally smaller than tenon size in a typical bolted configuration.

Accordingly, in one aspect, the present invention relates to a method of attaching a shroud cover segment to a plurality of gas turbine compressor stator vanes comprising: (a) forming each of the plurality of stator vanes with at least one tenon extending from a radially inner tip of each of the stator vanes; (b) forming the shroud cover segment with at least one aperture for each of the at least one tenon; (c) locating the plurality of stator vanes and the shroud cover segment such that the at least one tenon of each of the stator vanes projects through a respective aperture in the shroud cover; and (d) forming the at least one tenon of each of the plurality of stator vanes to create an enlarged tenon head on each of the tenons, thereby fixing said shroud cover segment to the plurality of stator vanes.

In another aspect, the invention relates to a method of attaching a shroud cover segment to a plurality of gas turbine compressor stator vanes comprising: (a) forming each of the plurality of stator vanes with a pair of tenons extending from a radially inner tip of each of the stator vanes; (b) forming the shroud cover segment with a pair of apertures for receiving said pair of tenons; (c) locating the plurality of stator vanes and the shroud cover segment such that the at least one tenon of each of the stator vanes projects through a respective aperture in the shroud cover; (d) forming the at least one tenon of each of the plurality of stator vanes to create an enlarged tenon head on each of the tenons, thereby fixing the shroud cover segment to the plurality of stator vanes; and (e) wherein step (d) is performed without preheat.

In still another aspect, the invention relates to a method of attaching a shroud cover segment to a plurality of gas turbine compressor stator vanes comprising: (a) forming each of the plurality of stator vanes with at least one tenon extending from a radially inner tip of each of the stator vanes; (b) forming the shroud cover segment with at least one aperture for each of the at least one tenon; (c) locating the plurality of stator vanes and the shroud cover segment such that the at least one tenon of each of the stator vanes projects through a respective aperture in the shroud cover; (d) forming, without preheating, the at least one tenon of each of the plurality of stator vanes to create an enlarged tenon head on each of the tenons, thereby fixing the shroud cover segment to the plurality of stator vanes; and (e) wherein the shroud cover segment extends no more than 180°.

The invention will now be described in connection with the drawings identified below.

### BRIEF DESCRIPTION OF THE DRAWING

FIG. 1 is a perspective view of a typical welded gas turbine stator vane shroud connection;

FIG. 2 is a perspective view of a typical bolted gas turbine stator vane connection;

FIG. 3 is a perspective view of a formed gas turbine stator vane connection in accordance with an exemplary embodiment of the invention;

FIG. 4 a partial, sectional perspective view of a tenon projecting view through a hole in a tip shroud prior to forming;

FIG. 5 is a partial, sectional perspective view of the assembly in FIG. 4 but with the free end of the tenon formed in accordance with an exemplary embodiment of the invention; and

FIG. 6 is a partial perspective view of a formed vane and shroud assembly similar to FIG. 5 but showing a pair of formed tenons.

### DETAILED DESCRIPTION OF THE INVENTION

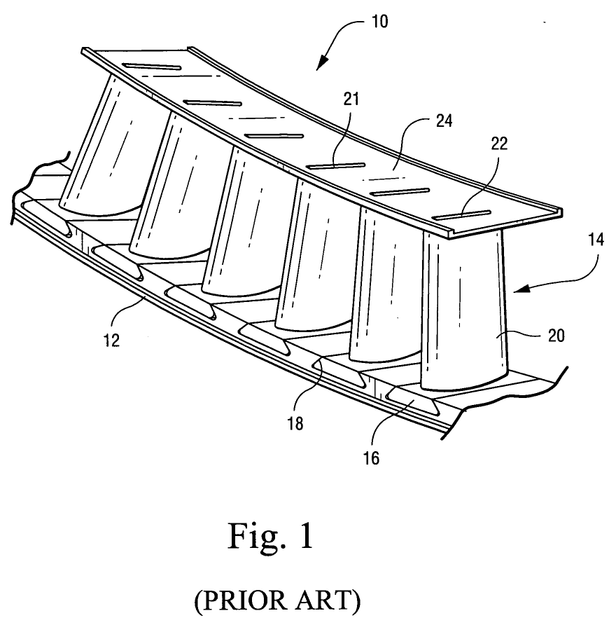

With reference to FIG. 1, a typical welded gas turbine stator vane shroud connection is illustrated. More specifically, a stator vane and shroud assembly 10 is made up of an annular stator ring 12 to which is secured a plurality of stator vanes 14. Each stator vane includes a dovetail mounting portion 16 that is slidably received within a complimentary dovetail shaped slot 18 in the stator ring. It will be appreciated, however, that other mounting techniques for securing the vanes to the stator ring may be employed. The stator vanes also include an airfoil portion 20, the radially inner edge of which is formed with a tenon 21 received within a slot or opening 22 in an annular stator vane shroud 24. In this arrangement, the shroud 24 is welded to the tenons of the respective vanes 14 in a set of vanes that are to be attached to the shroud. In this regard, the shroud cover 24 typically comprises plural arcuate segments, each of which spans a predetermined number of stator vanes within an arcuate extent of, for example, no more than 180°. The arcuate extent of the cover segments, and thus the number of stator vanes attached to each cover segment, may be varied in accordance with specific applications.

The shroud cover, or shroud cover segment, 24 is machined to exacting tolerances to hold tight clearances between the shroud cover and the tenons of the vanes to ensure full penetration welds. After welding, the shroud-to-stator vane assembly must be machined to remove any warpage due to the welding process. The assembly must also be preheated treated and postheat treated to relieve any residual stress due to heat input.

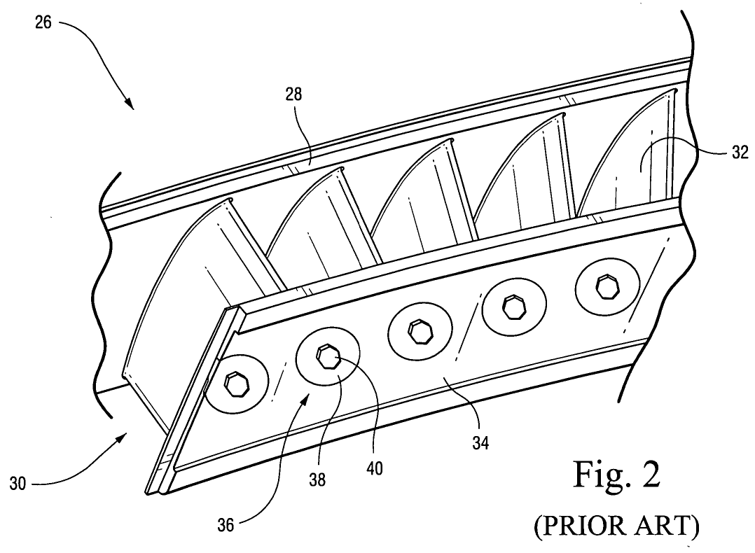

FIG. 2 illustrates another known gas turbine stator vane-to-shroud connection that utilizes bolts. More specifically, the assembly 26 again includes an annular stator ring 28 mounting a plurality of stator vanes 30. Each of the stator vanes includes an airfoil portion 32, the radially inner ends of which are secured to an annular shroud cover (or shroud cover segment) 34. Tenons (not shown) on the inner tips of the stator vanes are seated in slots (also not shown) in the shroud and an assembly 36 including a threaded bolt 38 and washer 3 (as well as a bushing not visible in FIG. 2) are utilized to secure the shroud to the stator vanes. As will be appreciated, this arrangement increases the number of required parts as well as the time of assembly, and raises the potential for over-torqued bolts.

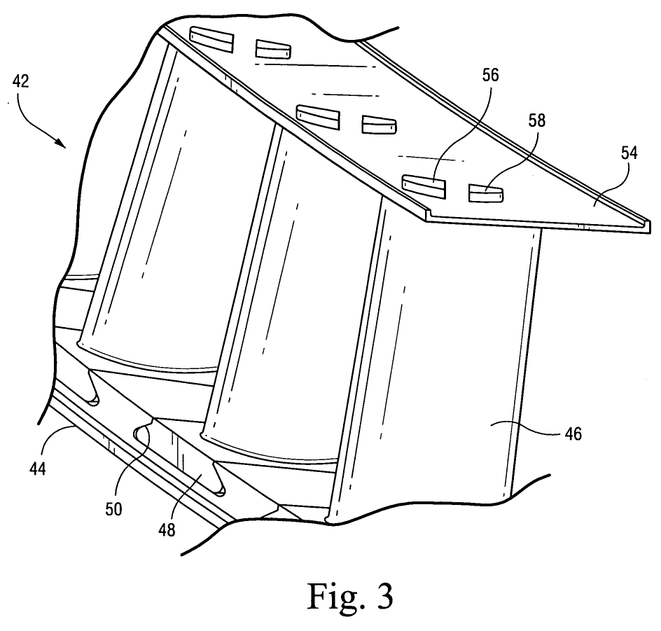

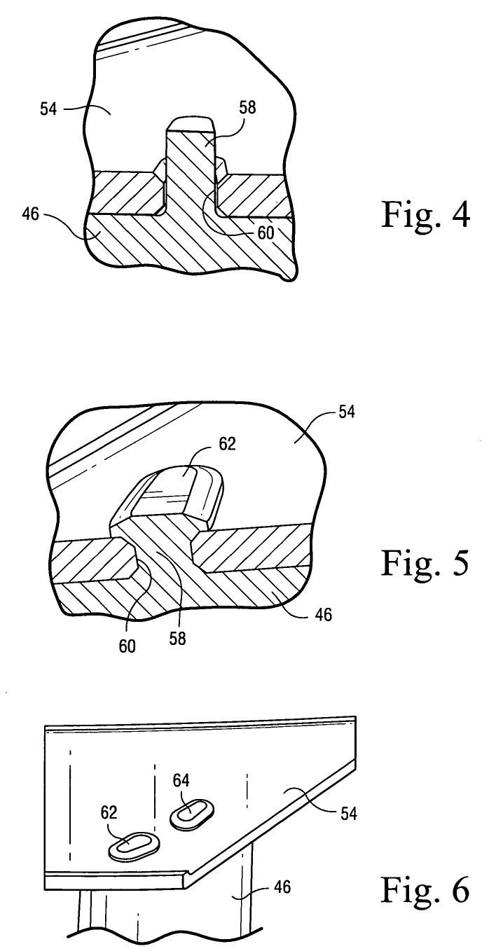

FIGS. 3-6 illustrate a formed gas turbine stator vane-to-shroud connection in accordance with an exemplary embodiment of the invention. The assembly 42 includes an annular stator ring 44 that mounts a plurality of stator vanes 46. The stator vanes 46 include dovetail mounting portions 48 that are received in complimentary dovetail slots 50 in the stator ring. At their opposite ends (i.e., radially inner ends), the stator vanes 52 each include a pair of projecting tenons (having substantially uniform cross-sections in the vertical direction) 56, 58 that are received in complimentary-shaped chamfered openings 60 in the vane shroud or shroud segment 54, as best seen in FIG. 4.

The projecting tenons are subsequently formed utilizing otherwise conventional tools, with the resulting deformation of, for example, tenon 58, shown in FIG. 5. Note that the tenon 58 has been deformed to include an enlarged head 62 that securely locks the vane shroud or shroud segment 54 to the individual stator vanes 46 within a defined arcuate segment of the stator. FIG. 6 illustrates the manner in which both tenons 56 and 58 are reformed into enlarged heads 62, 64 for each of the stator vanes 46 in the set of vanes engaged by the shroud cover or should cover segment 54.

It will be appreciated that the tenon heads 62 can be cold or hot formed or peened using a manual pneumatic gun impacting the tenons, or by an automated pneumatic head impacting the tenons. The tenon heads can also be formed by non-impacting processes such as orbital head forming or radial head forming.

The use of a pair of tenons 56, 58 for each stator vane 46 produces a fixed end condition that provides the same fixity as a welded connection. Moreover, the process control with peening is much simpler than welding insofar as the tenon holes cut in the shroud are used to position the shroud in relation to the stator vanes. Another advantage to utilization of the peening process is that no preheating is required and therefore, distortion due to heat is not a factor. Nor is any machining required in order to meet assembly tolerances.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of attaching a shroud cover segment to a plurality of gas turbine compressor stator vanes comprising:
(a) forming each of the plurality of stator vanes with at least one tenon extending from a radially inner tip of each of said stator vanes;
(b) forming the shroud cover segment with at least one aperture for each of said at least one tenon;
(c) locating said plurality of stator vanes and said shroud cover segment such that said at least one tenon of each of said stator vanes projects through a respective aperture in said shroud cover; and
(d) forming said at least one tenon of each of said plurality of stator vanes to create an enlarged tenon head on each of said tenons, thereby fixing said shroud cover segment to said plurality of stator vanes.

2. The method of claim 1 wherein said at least one tenon comprises a pair of tenons and said at least one aperture comprises a pair of apertures.

3. The method of claim 1 wherein said shroud cover segment engages at least two of said plurality of stator vanes.

4. The method of claim 2 wherein step (d) is performed without preheat.

5. The method of claim 1 wherein, during step (b), each aperture is chamfered on opposite sides thereof.

6. The method of claim 1 wherein prior to step (c), said plurality of stator vanes are mounted to a stator ring.

7. A method of attaching a shroud cover segment to a plurality of gas turbine compressor stator vanes comprising:
(a) forming each of the plurality of stator vanes with a pair of tenons extending from a radially inner tip of each of said stator vanes;
(b) forming the shroud cover segment with a pair of apertures for receiving said pair of tenons;
(c) locating said plurality of stator vanes and said shroud cover segment such that said at least one tenon of each of said stator vanes projects through a respective aperture in said shroud cover;
(d) forming said at least one tenon of each of said plurality of stator vanes to create an enlarged tenon head on each of said tenons, thereby fixing said shroud cover segment to said plurality of stator vanes; and
wherein step (d) is performed without preheat.

8. The method of claim 7 wherein said shroud cover segment engages at least two of said plurality of stator vanes.

9. The method of claim 7 wherein, during step (b), each aperture is chamfered on opposite sides thereof.

10. The method of claim 7 wherein prior to step (c), said plurality of stator vanes are mounted to a stator ring.

11. A method of attaching a shroud cover segment to a plurality of gas turbine compressor stator vanes comprising:
(a) forming each of the plurality of stator vanes with at least one tenon extending from a radially inner tip of each of said stator vanes;
(b) forming the shroud cover segment with at least one aperture for each of said at least one tenon;
(c) locating said plurality of stator vanes and said shroud cover segment such that said at least one tenon of each of said stator vanes projects through a respective aperture in said shroud cover;
(d) forming, without preheating, said at least one tenon of each of said plurality of stator vanes to create an enlarged tenon head on each of said tenons, thereby fixing said shroud cover segment to said plurality of stator vanes; and
wherein said shroud cover segment extends no more than 180°.

12. The method of claim 11 wherein said at least one tenon comprises a pair of tenons and said at least one aperture comprises a pair of apertures.
